(19) United States
(12) Patent Application Publication
(10) Pub. No.: US 2017/0307420 A1
(43) Pub. Date: Oct. 26, 2017

(54) PROBE STRUCTURE

(71) Applicant: Neural Analytics, Inc., Los Angeles, CA (US)

(72) Inventors: Roman Flores, II, Los Angeles, CA (US); Matthew Hutter, Los Angeles, CA (US); Gerard Salinas, Los Angeles, CA (US); Michael Costa, Los Angeles, CA (US); Matthew Sylvester, Los Angeles, CA (US); Seth J. Wilk, Los Angeles, CA (US)

(21) Appl. No.: 15/497,039

(22) Filed: Apr. 25, 2017

Related U.S. Application Data
(63) Continuation-in-part of application No. 15/399,440, filed on Jan. 5, 2017.
Application No. 15/399,440 is a continuation-in-part of application No. 15/399,735, filed on Jan. 5, 2017.
(60) Provisional application No. 62/327,363, filed on Apr. 25, 2016.

(51) Int. Cl. G01D 11/18; G01N 29/24; G01N 21/359

(52) U.S. Cl. CPC G01D 11/18; G01N 21/359; G01N 29/24

(57) ABSTRACT

In various embodiments, a probe structure is provided. In some embodiments, the probe structure includes a probe body. In some embodiments, the probe structure further includes a plurality of fingers adapted to extend outwards from the probe body. In some embodiments, the probe structure further includes a spring including a plurality of coils adapted to wrap around the probe body and compressed between a compression plane and probe body. In some embodiments, the end coil of the plurality of coils is configured to encircle the plurality of fingers. In some embodiments, the compression plane is a grip held by a human operator. In some embodiments, the compression plane is a robotic end effector that positions itself over any topography.

### CROSS-REFERENCE TO RELATED APPLICATIONS

This application claims the benefit of and priority to U.S. provisional patent application Ser. No. 62/327,363, filed Apr. 25, 2016, the contents of which are incorporated herein by reference in its entirety. This application is a continuation-in-part of U.S. patent application Ser. No. 15/399,440, filed Jan. 5, 2017 and a continuation-in-part of U.S. patent application Ser. No. 15/399,735, filed Jan. 5, 2017, the contents of which are incorporated herein by reference in their entireties.

### BACKGROUND

### 1. Field

Subject matter described herein relates generally to medical devices, and more particularly to a probe for diagnosing medical conditions.

### 2. Background

For devices utilizing a probe (e.g., an automated Transcranial Doppler device), there exist concerns related to alignment and pressure that the probe exerts during use (e.g., for comfortability when held against a human or for ensuring the effectiveness of the probe).

Automated solutions may require a closed loop system and related control electronics that are expensive and difficult to manufacture. This system would need to control the force and pressure of a probe when in contact with a surface. For example, the system is a robot which guides the probe and is an end effector that positions itself over any topography. In some solutions, if a spring is incorporated within a probe, but may not be effective for force and pressure control due to lateral slippage and shifting of the spring within the probe.

### SUMMARY

In general, various embodiments relate to systems and methods for a passively adaptive system for different operating systems that dampens with a spring constant k. Other embodiments may include rubber, air bladder, magnets, or a suspension system.

According to various embodiments, there is provided an apparatus including a probe body, a spring securing elements coupled to probe body, and a spring comprising a plurality of coils coupled to the probe body. In some embodiments, an end coil of the plurality of coils is configured to encircle the spring securing element. In some embodiments, the spring securing element is adapted to extend outward from the probe body. In some embodiments, the probe body emits acoustic energy from a first end. In some embodiments, the probe body is an ultrasound probe. In some embodiments, the probe body is a Transcranial Doppler (TCD) probe. In some embodiments, the probe body is an array of transducers. In some embodiments, the probe body is an Ultrasound Imaging probe. In some embodiments, the probe body is an NIRS (Near Infrared Spectroscopy) probe. In some embodiments, the probe body is a thermal imaging sensor. In some embodiments, the probe body includes a threaded section. In some embodiments, the threaded section is configured to connect to a position control device. In some embodiments, the threaded section is connected to a stopper allowing the probe to travel and compress the spring against a compression plane. In some embodiments, the threaded section is connected to a grip. In some embodiments, the spring securing element is at a first end of a shaft, which first end is opposite a second end of the shaft adjacent to the threaded section. In some embodiments, the spring securing element is adapted to receive or hold one or more of the plurality of coils. In some embodiments, the spring securing element includes a plurality of fingers. In some embodiments, the spring securing element includes a ring.

According to various embodiments, there is provided an apparatus including a probe structure, including a spring comprising a plurality of coils coupled to a probe body, and a compression plane that attaches to probe structure and compresses the spring. In some embodiments, the probe body includes a threaded section. In some embodiments, the compression plane attaches to a grip. In some embodiments, the threaded section is connected to a grip. In some embodiments, a stopper is located on the opposite side of the compression plane from the spring. In some embodiments, the compression plane provides pressure applied to the spring during an operation of the probe.

According to various embodiments, there is provided a probe structure. In some embodiments, the probe structure includes a probe body. In some embodiments, the probe structure further includes a plurality of fingers adapted to extend outwards from the probe body. In some embodiments, the probe structure further includes a spring including a plurality of coils adapted to wrap around the probe body, and an end coil of the plurality of coils configured to encircle the plurality of fingers.

According to various embodiments, there is provided a method of manufacturing a probe structure. In some embodiments, the method includes providing a probe body. In some embodiments, the method further includes supplying a plurality of fingers adapted to extend outwards from the probe body. In some embodiments, the method further includes installing a spring including a plurality of coils adapted to wrap around the probe body, an end coil of the plurality of coils configured to encircle the plurality of fingers.

### BRIEF DESCRIPTION OF THE DRAWINGS

FIG. 1 illustrates a perspective view of a probe structure according to various embodiments.

FIG. 2 illustrates a perspective view of a probe body according to various embodiments.

FIG. 3A illustrates a side view of a spring according to various embodiments.

FIG. 3B illustrates a perspective cross-sectional view of a probe structure according to various embodiments.

FIG. 3C illustrates a side cross-sectional view of a probe structure according to various embodiments.

FIG. 4A illustrates an isolated view of a spring receptacle of a probe body according to various embodiments.

FIG. 4B illustrates a top view of a probe body according to various embodiments.

FIG. 5 illustrates an exploded view of a probe structure and a gimbal interface according to various embodiments.

FIG. 6A illustrates a perspective view of a probe structure according to various embodiments.

FIG. 6B illustrates a perspective view of a probe structure according to various embodiments.

FIG. 6C illustrates a perspective view of a probe structure according to various embodiments.

FIG. 7 illustrates a side cross-sectional view of a probe structure according to various embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for providing a thorough understanding of various concepts. However, it will be apparent to those skilled in the art that these concepts may be practiced without these specific details. In some instances, well-known structures and components are shown in block diagram form in order to avoid obscuring such concepts.

In several embodiments, the apparatus and systems are manufactured from, but not limited to, metal, hard plastic, metals, aluminum, steel, titanium, magnesium, various alloys, rigid plastics, composites, carbon fiber, fiber glass, expanded foam, compression molded foam, SLA or FDM-made materials, RIM molding, ABS, TPO, nylon, PVC, fiber reinforced resins, or the like.

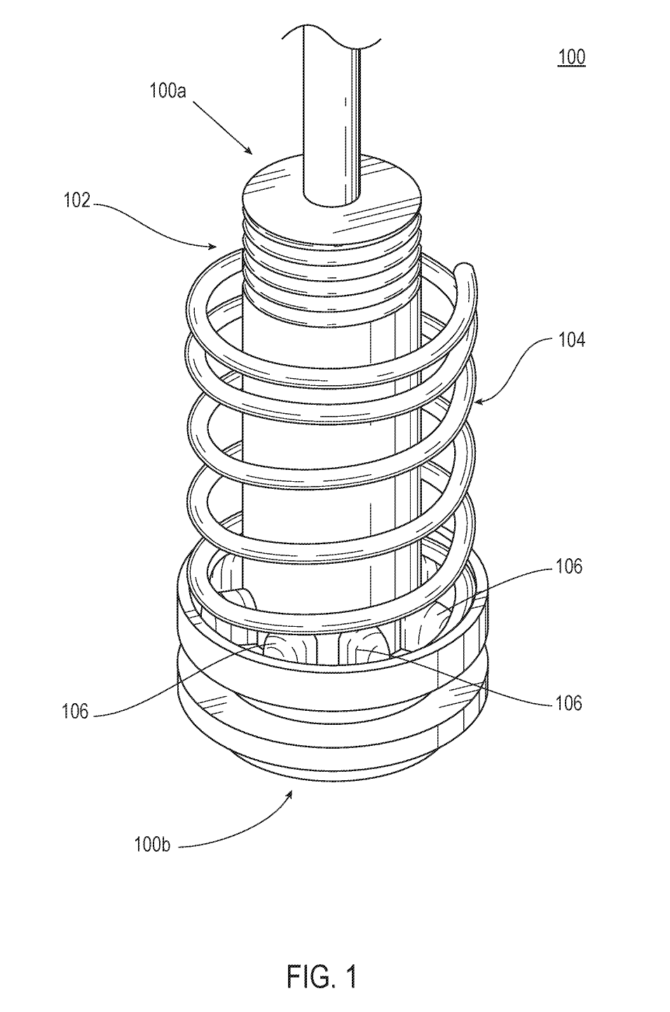

FIG. 1 illustrates a perspective view of a probe structure 100 according to various embodiments. Referring to FIG. 1, in some embodiments, the probe structure 100 has a first end 100a and a second end 100b. In some embodiments, the first end 100a interfaces with a controller, such as, but not limited to, a motor assembly and the like for controlling the probe structure 100 (e.g., control z-axis pressure, normal alignment, or the like of the probe structure 100). In some embodiments the second end 100b contacts a surface on which the probe structure 100 operates. For example, in some embodiments the second end 100b is configured to contact human skin for operation of the probe structure 100.

In some embodiments, the probe structure is part of a Transcranial Doppler (TCD) apparatus such that the second end 100b of the probe structure 100 is configured to contact and align along a human head, and the first end 100a of the probe structure 100 is connected to the TCD apparatus to provide ultrasound wave emission out of the second end 100b. In other embodiments, the probe structure 100 is configured to emit other types of waves during operation, such as, but not limited to, infrared waves, acoustic, Near Infrared Spectroscopy (NIRS), transducer, TCD, x-rays, and so on.

In some embodiments, the probe structure 100 includes a probe body 102, a spring 104, and a spring securing element, which may be a plurality of fingers 106. In some embodiments the spring 104 wraps around or encircle the probe body 102. In some embodiments the spring 104 provides increased control of and stability to the probe structure 100 during operation. In some embodiments, the fingers 106 extend outwards from the probe body 102 to prevent movement of the spring 104 away from the probe body 102. In some embodiments the fingers 106 interface with one or more coils of the spring 104.

In some embodiments, the probe body 102 may include a TCD probe, Ultrasound probe, a Phased Array probe, or an array of transducers.

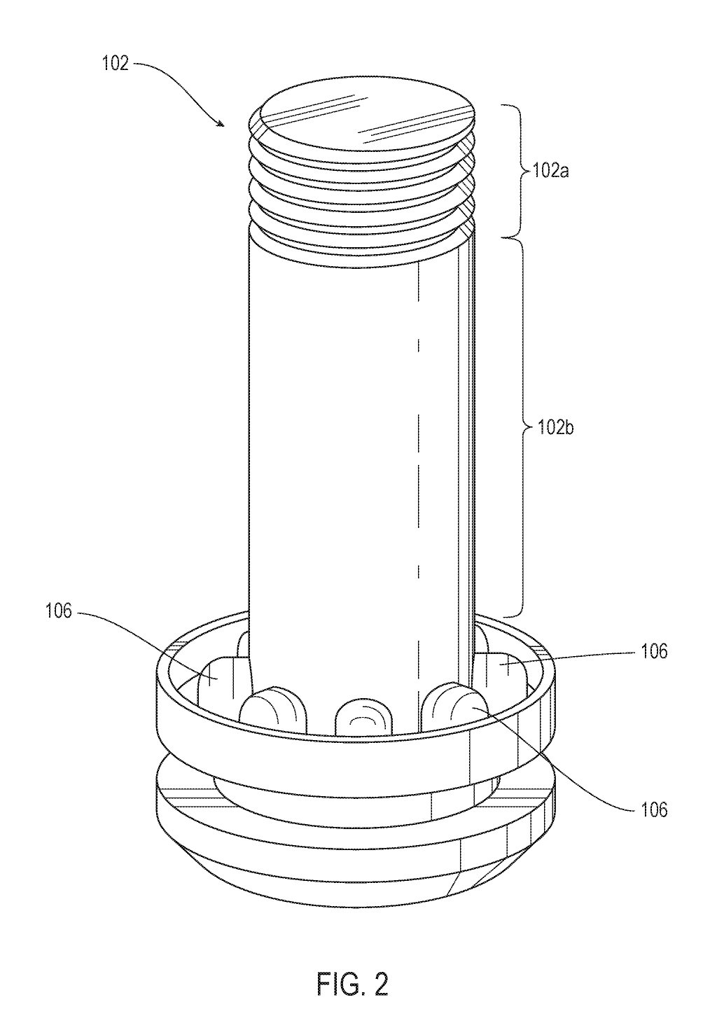

FIG. 2 illustrates a perspective view of the probe body 102 according to various embodiments. Referring to FIG. 1 and FIG. 2, in some embodiments, the probe body 102 includes a threaded section 102a and a shaft 102b. In some embodiments, the threaded section 102a includes a plurality of threads along a portion of the length of the probe body 102. In some embodiments, the threaded section 102a is located at an end of the probe body 102 (e.g., at a portion of the probe body 102 corresponding to the first end 100a of the probe structure 100). In some embodiments, the plurality of threads extends circumferentially around the probe body 102. In some embodiments, the threaded section 102a is configured to interface and connect with other components of a device (e.g., a TCD device). For example, in some embodiments, the threaded section 102a interfaces with a gimbal component. Alternatively, in other embodiments the threaded section 102a interfaces with a robot which guides the probe and is an end effector that positions itself over any topography or is a grip such that the entire system is positioned by a human operator.

In some embodiments, the threaded section 102a includes any suitable number of threads for interfacing and securely connecting the probe structure 100 to a separate device, such as a position control device. For example, in some embodiments the probe body 102 includes five or six revolutions of threads. In other embodiments, the probe body 102 includes more than six threads or fewer than five threads. In addition, in some embodiments, adjacent threads of the threaded section 102a are offset from each other at a constant distance, such as, but not limited to, 1/16th inch.

In some embodiments, the shaft 102b extends from the threaded section 102a to the plurality of fingers 106. As such, in some embodiments, the spring 104 extends from the fingers 106, along the shaft 102b, and over the threaded section 102a. In some embodiments, the length of the shaft 102b corresponds to a length of the spring 104 (e.g., the length of the shaft 102b is at least as long as the length of the spring 104). In some embodiments, the shaft 102b is cylindrical. In other embodiments, the shaft 102b is any other suitable shape, such as, but not limited to, rectangular, polygonal, or the like.

In some embodiments, the plurality of fingers 106 extend outwards from the shaft 102b. In some embodiments, the fingers 106 are located at an end of the shaft 102b opposite the end of the shaft 102b adjacent the threaded section 102a. In other words, in some embodiments, the plurality of fingers 106 are located proximate the second end 100b of the probe structure 100. In some embodiments, the plurality of fingers 106 are adapted to receive or hold one or more coils of the spring 104 such that the coil wraps around the fingers 106 (e.g., at least one full revolution of a coil wraps around the fingers 106). In some embodiments, each of the plurality of fingers 106 are evenly spaced from each other around the circumference of the shaft 102b. Furthermore, in some embodiments, each of the fingers 106 protrudes from the shaft 102b at substantially similar or at the same length as each other.

In some embodiments, the fingers 106 protrude from the shaft 102b at a length for restraining and holding one or more coils of the spring 104. In other words, in some embodiments, the fingers 106 protrude at a length such that when one or more coils of the spring 104 is wrapped around the fingers 106, there is minimal or no space between the fingers 106 and the coil so that the coil is held securely by the fingers. For example, in some embodiments, each of the plurality of fingers 106 protrudes from the probe body 102 at a length of about 0.11 inches. In some embodiments, the coil that encircles the fingers 106 contacts each of the fingers 106. In some embodiments, the number of fingers 106 is any suitable number for holding a spring 104 in place and preventing lateral movement or shifting of the spring 104 when positioned over the probe body 102. In some embodiments, the number of fingers 106 is three or more.

In some embodiments, the probe body 102, the threaded section 102a, the shaft 102b, and/or the fingers 106 are made from any suitable rigid material for allowing the transmission of waves, electromagnetic energy, or acoustic waves (e.g., ultrasound waves), such as, but not limited to, plastics including acrylonitrile butadiene styrene (ABS), polyoxymethylene (POM), acetal, polyacetal, polyformaldehyde, combinations thereof, or the like. In some embodiments, the probe body 102, the threaded section 102a, the shaft 102b, and/or the fingers 106 are made from a material capable of withstanding water-based liquids (e.g., ultrasound gel). In some embodiments, the threaded section 102a, the shaft 102b, and the plurality of fingers 106 are made from the same material. In other embodiments, the threaded section 102a, the shaft 102b, and the plurality of fingers 106 are made from different materials, or two of the elements are made from the same materials different from that which the third element is made from (e.g., the threaded section 102a and the shaft 102b are made from the same material, and the fingers are made from a different material than that of the threaded section 102a and the shaft 102b).

In some embodiments, the probe body 102 can be made by any suitable method of manufacturing, such as, but not limited to, overmolding or the like. In particular embodiments, the probe body 102, the threaded section 102a, the shaft 102b, and/or the fingers 106 are machined. In other embodiments, the probe body 102, the threaded section 102a, the shaft 102b, and/or the fingers 106 are injection molded. In some embodiments, the probe body 102, the threaded section 102a, the shaft 102b, and/or the fingers 106 are designed with uniform thickness to prevent sink marks, short shots, and flow marks.

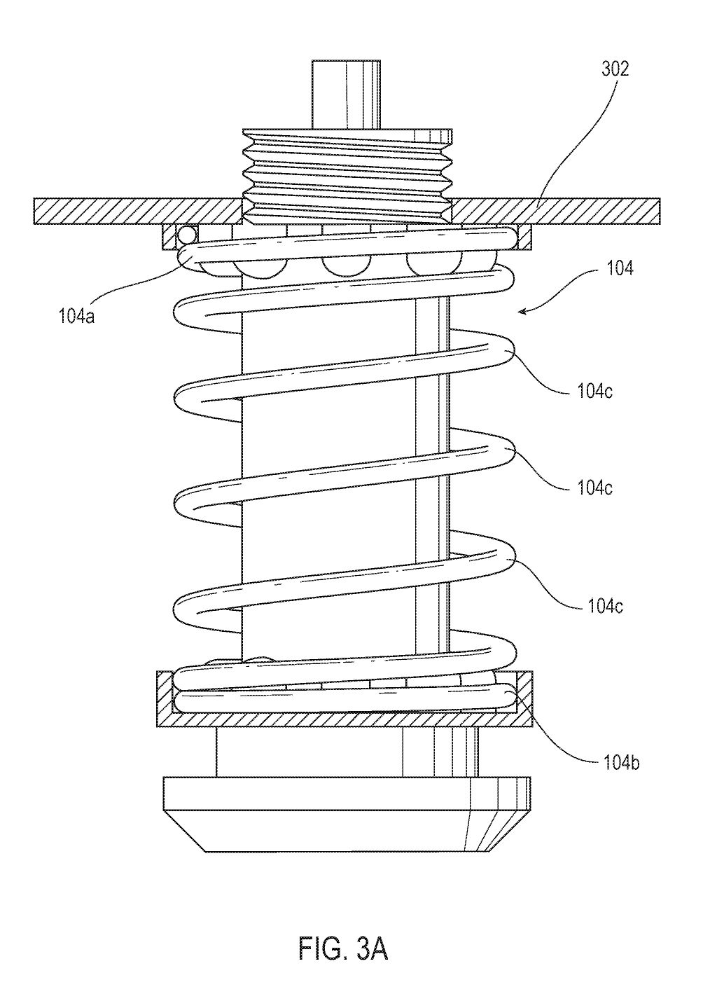

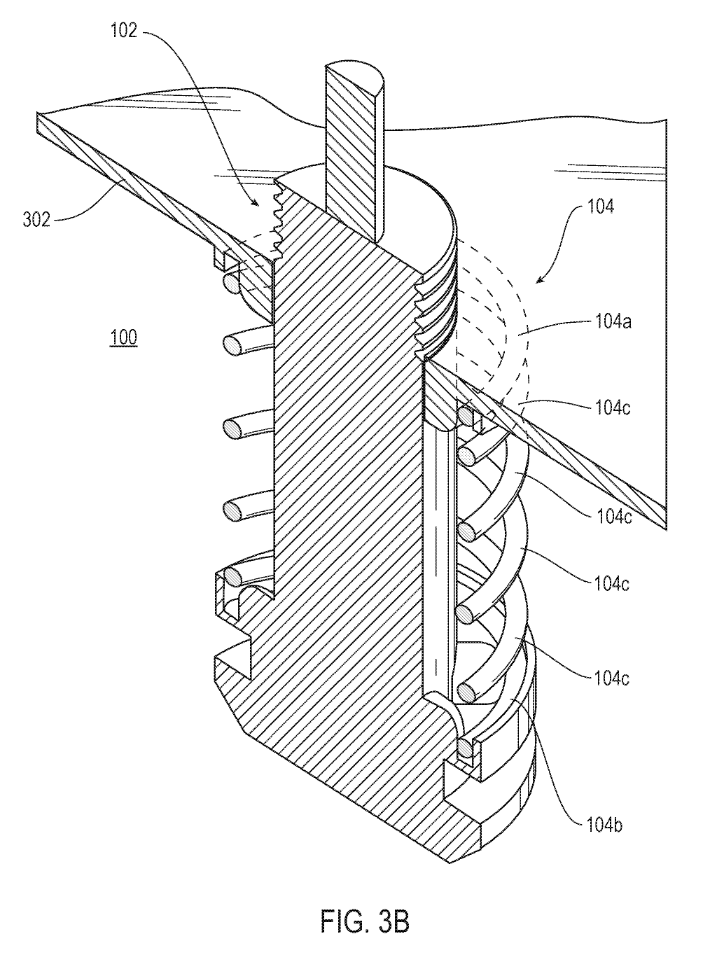

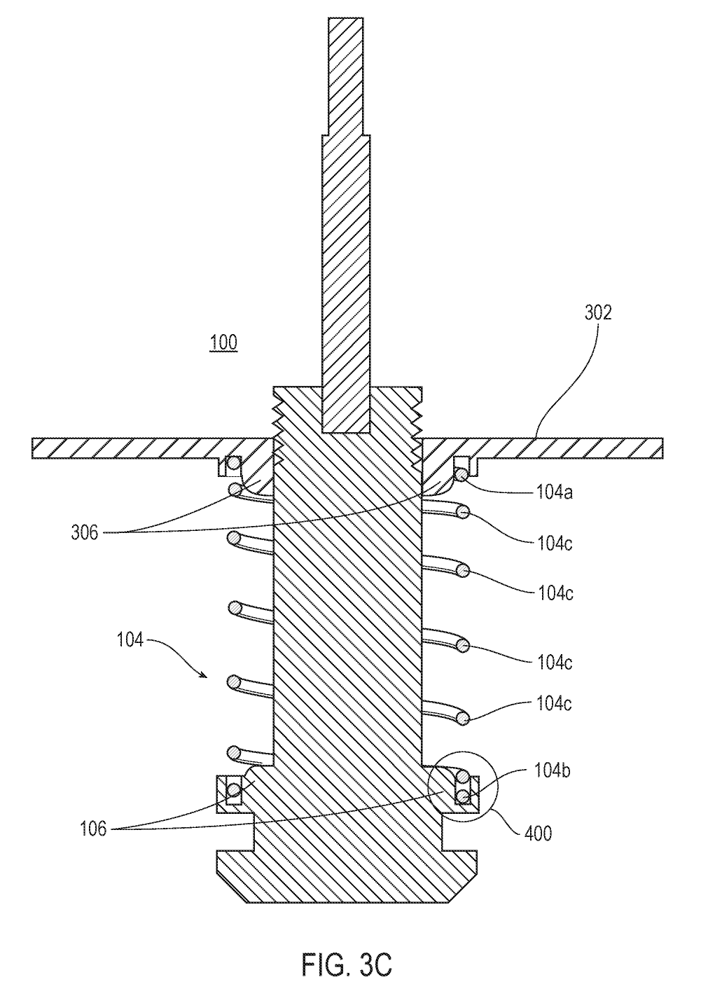

FIG. 3A illustrates a side view of a spring according to various embodiments. Referring to FIGS. 1-3A, in some embodiments, the spring 104 includes a plurality of coils. In some embodiments, the spring 104 is in the shape of a helix and encircles the probe body 102 (e.g., around a portion or an entire length of the threaded section 102a, the shaft 102b, and/or the fingers 106). In some embodiments, the spring 104 is made from any suitable rigid and compressible material, such as, but not limited to, steel, bronze, titanium, plastic, or the like.

In some embodiments, the spring 104 includes a first end coil 104a, a second end coil 104b, and a plurality of intermediary coils 104c. In some embodiments, the first end coil 104a is located at the first end 100a of the probe structure 100, and the second end coil 104b is located at the second end 100b of the probe structure 100. In some embodiments, each of the first end coil 104a and/or the second end coil 104b is a coil having at least one full revolution of the spring 104. In some embodiments, the plurality of intermediary coils 104c are located between the first end coil 104a and the second end coil 104b. In some embodiments, the first end coil 104a and the second end coil 104b are substantially parallel to each other.

In some embodiments, a horizontal plane is defined by each of the first end coil 104a and/or the second end coil 104b, with the horizontal plane extending along the diameter of the first end coil 104a or the second end coil 104b. For example, in some embodiments, each of the first end coil 104a and the second end coil 104b defines separate and parallel horizontal planes. In some embodiments, the first end coil 104a and/or the second end coil 104b are oriented substantially perpendicular (e.g., oriented along their respective horizontal planes) with respect to the length of the shaft 102b (e.g., the length of the shaft 102b extending from the first end 100a to the second end 100b of the probe structure 100). In some embodiments, the intermediary coils 104c are tilted or angled with respect to the horizontal plane, while the first end coil 104a and the second end coil 104b are substantially planar or parallel to the horizontal plane. In some embodiments, the first end coil 104a and/or the second end coil 104b have a slight angle or pitch (e.g., a 0.1 inch pitch) such that the first end coil 104a and/or the second end coil 104b are not completely perpendicular to the length of the shaft 102b.

Accordingly, in some embodiments, the second end coil 104b contacts the plurality of fingers 106 by wrapping around the outer surfaces of the respective fingers 106. In some embodiments, the diameter of the second end coil 104b corresponds to the diameter formed by the plurality of fingers 106 such that the second end coil 104b securely contacts each of the fingers 106 when encircling the fingers 106. For example, In some embodiments, when the inner surface of the second end coil 104b contacts each of the fingers 106, the spring 104 is restricted or substantially restricted from lateral movement because the fingers 106 prevent such movement.

In other embodiments, the diameter of the second end coil 104b is slightly larger than the diameter formed by the plurality of fingers 106 such that the second end coil 104b does not contact or loosely contacts one or more of the fingers 106 when encircling the fingers 106. For example, in some embodiments, when the inner surface of the second end coil 104b contacts the fingers 106, the spring 104 is still capable of minor lateral movement. However, in such embodiments, although the spring 104 is capable of slight lateral shifting, the spring 104 is still substantially restricted from lateral movement such that the spring 104 substantially remains in place. As such, the spring 104 is allowed to distort (e.g., compress), while remaining centered within the probe structure 100.

Accordingly, in some embodiments, the fingers 106 and the spring 104 act as a probe-centering mechanism for a device utilizing the probe structure 100. In other words, in some embodiments, the spring 104 and the fingers 106 work to align and maintain the probe structure 100 to a default position, which, in some embodiments, is normal to a scan surface of the probe structure 100 during lateral surface translations (e.g., during movement of the probe structure 100 along skin of a user). As such, in some embodiments, the spring 104 acts as a compression element for positioning and alignment of the probe structure 100 for optimizing effectiveness of ultrasound wave signals.

In addition, FIG. 3A illustrates a compression plane 302. In some embodiments, the compression plane 302 is located near and contacts the first end coil 104a. In some embodiments, the compression plane 302 represents a structure that attaches to the probe structure 100 that compresses the spring 104. For example, in some embodiments, the compression plane 302 compresses or decompresses the spring 104 during placement and force control of the probe structure 100. In some embodiments, the compression plane 302 applies pressure to the spring 104 during operation of a TCD device. In some embodiments, the compression plane 302 is sufficiently deep to receive the probe into it. In some embodiments, the compression plane 302 is a robotic end effector that positions itself over any topography. In some embodiments, the receptacle in compression plane 302 for the probe may be shaped other than round such as square or polygon to control the probe body from rotating.

FIG. 3B illustrates a perspective cross-sectional view of the probe structure 100 according to various embodiments. FIG. 3C illustrates a side cross-sectional view of the probe structure 100 according to various embodiments. Referring to FIGS. 1-3C, in some embodiments, the probe structure 100 includes a spring receptacle 400. In some embodiments, the inner surface of the second end coil 104b wraps around and contacts the plurality of fingers 106. In some embodiments, the second end coil 104b includes a plurality of end coils that wrap around the fingers 106. In some embodiments, the plurality of end coils are substantially similar to each other, for example, in shape, diameter, angle of tilt (e.g., pitch), or the like.

In some embodiments, the compression plane 302 also includes a plurality of fingers 306. In some embodiments, the description above corresponding to the fingers 106 is applicable to the fingers 306. In some embodiments, the first end coil 104a contacts and encircles the fingers 306. In some embodiments, the first end coil 104a corresponds to the second end coil 104b described above, and the disclosure related to the first end coil 104a is applicable to the second end coil 104b. As such, in some embodiments, the fingers 306 are adapted to contact and restrict lateral movement or shifting of the first end coil 104a such that the spring 104 is secured in place. In some embodiments, the probe structure 100 includes both the fingers 106 and the fingers 306 for increased securing of the spring 104 within the probe structure 100. In other embodiments, the probe structure 100 includes one of the fingers 106 or the fingers 306. In some embodiments, the compression plane 302 is sufficiently deep to receive the probe into it. In some embodiments, the receptacle in compression plane 302 for the probe may be shaped other than round such as square or polygon to control the probe body from rotating.

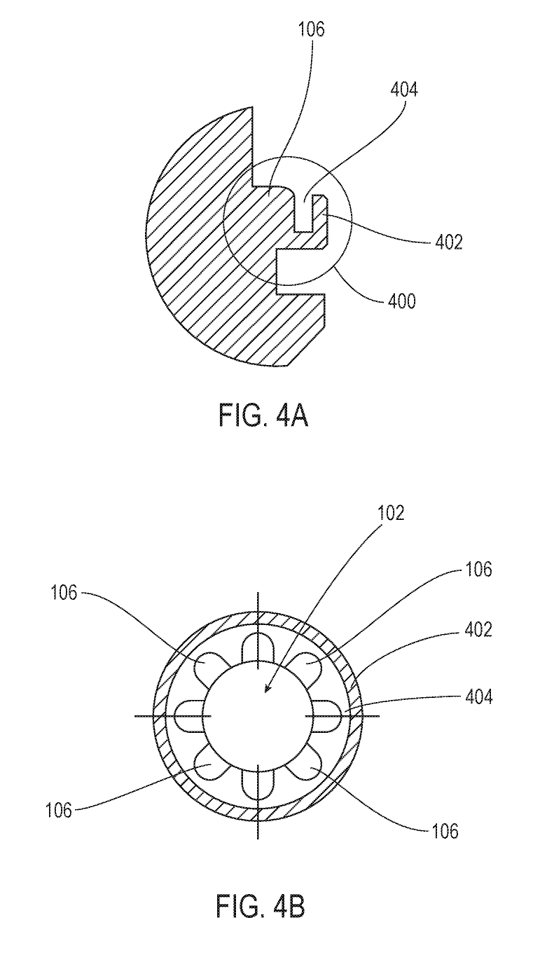

FIG. 4A illustrates an isolated view of the spring receptacle 400 of the probe body 102 according to various embodiments. Referring to FIGS. 1-4A, the spring receptacle 400 includes each of the plurality of fingers 106 and a retaining lip 402. In some embodiments, the retaining lip 402 is a continuous ridge that extends around the entire circumference of the probe body 102. In other embodiments, the retaining lip 402 is not continuous and positioned at discrete locations around the circumference of the probe body 102. For example, in some embodiments, the retaining lip 402 includes a plurality of discrete retaining lips that align with respective ones of the plurality of fingers 106.

In some embodiments, at locations where the retaining lip 402 and each of the plurality of fingers 106 align or overlap, a retaining cavity 404 is present. In some embodiments, the retaining cavity 404 is adapted to receive and retain the second end coil 104b. Accordingly, in some embodiments, because it is substantially planar or horizontal, the second end coil 104b is able to sit substantially flush with the inner surfaces of the retaining cavity 404 (e.g., by contacting the outer surfaces of the fingers 106, the inner wall of the retaining lip 402, and the upper surface of the retaining cavity 404). Accordingly, the second end coil 104b and the spring receptacle 400 are designed such that a maximum surface area of the second end coil 104b contacts surfaces within the spring receptacle 400.

In some embodiments, the retaining cavity 404 between each of the fingers 106 and the retaining lip 402 is wide enough to accommodate and receive the second end coil 104b, but narrow enough to restrict lateral movement of the second end coil 104b. For example, in some embodiments, the retaining cavity 404 has a width of about 0.05 inches. In some embodiments, the retaining cavity 404 has a depth suitable for retaining the spring 104 (e.g., such that the spring 104 is not able to slip out of the retaining cavity 404). For example, in some embodiments, the retaining cavity 404 has a depth of about 0.13 inches.

Accordingly, the spring receptacle 400 including the fingers 106 and the retaining lip 402 provides retention of the spring 104 when the spring 104 is positioned within the spring receptacle 400.

FIG. 4B illustrates a top view of the probe body 102 according to various embodiments. Referring to FIGS. 1-4B, in some embodiments, the probe body 102 includes the plurality of fingers 106 extending from the probe body 102. In some embodiments, the retaining lip 402 encircles the plurality of fingers 106 to provide a retaining cavity 404 at each location corresponding to the location of each of the fingers 106.

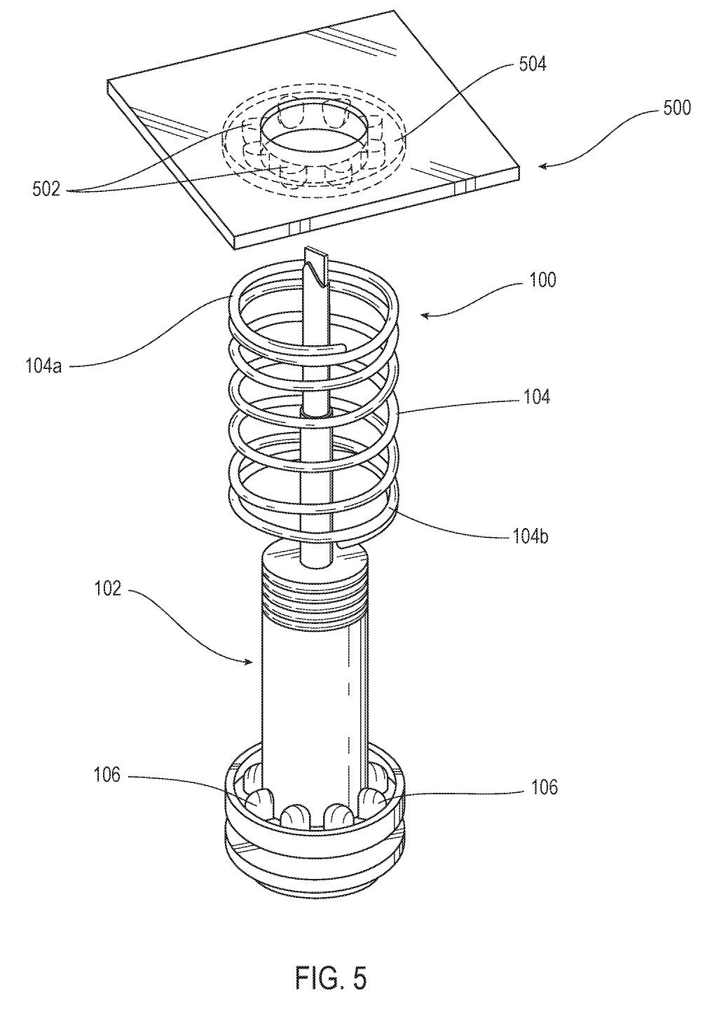

FIG. 5 illustrates an exploded view of the probe structure 100 and a gimbal interface 500 according to various embodiments. Referring to FIGS. 1-5, in some embodiments, the gimbal interface 500 is adapted to connect the probe structure 100 to a gimbal. In some embodiments, the gimbal is an apparatus for controlling movement and positioning of the probe structure 100. In some embodiments, the gimbal interface 500 includes a plurality of fingers 502 and a retaining lip 504. In some embodiments, the above description concerning the plurality of fingers 106 and 306 is applicable to the fingers 502. Similarly, in some embodiments, the above description concerning the retaining lip 402 is applicable to the retaining lip 504.

In some embodiments, the gimbal interface 500 is adapted to connect to the probe structure 100 via the first end coil 104a. In some embodiments, the plurality of fingers 502 contact an inner circular surface of the first end coil 104a such that the first end coil 104a is secured by the fingers 502. In addition, in some embodiments, the retaining lip 504 provides further stability to the interconnection between the first end coil 104a and the gimbal interface 500. Accordingly, in some embodiments, the probe structure 100 is coupled to the gimbal interface 500 at a first side or surface of the gimbal interface 500, and the gimbal is coupled to the gimbal interface 500 at a second side or surface of the gimbal interface, such that the gimbal is coupled to the probe structure 100 via the gimbal interface 500. In some embodiments, the first side or surface of the gimbal interface 500 is opposite the second side or surface of the gimbal interface.

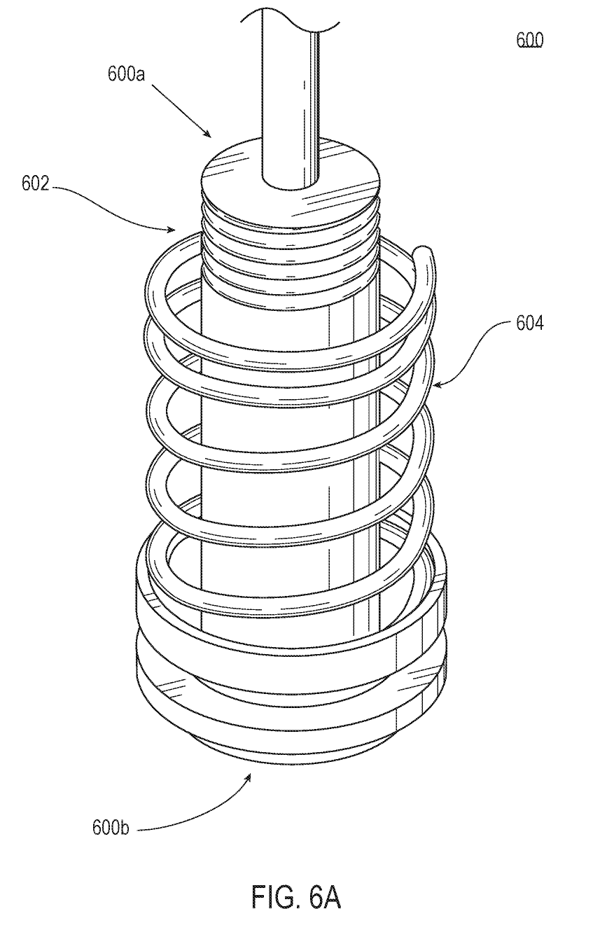

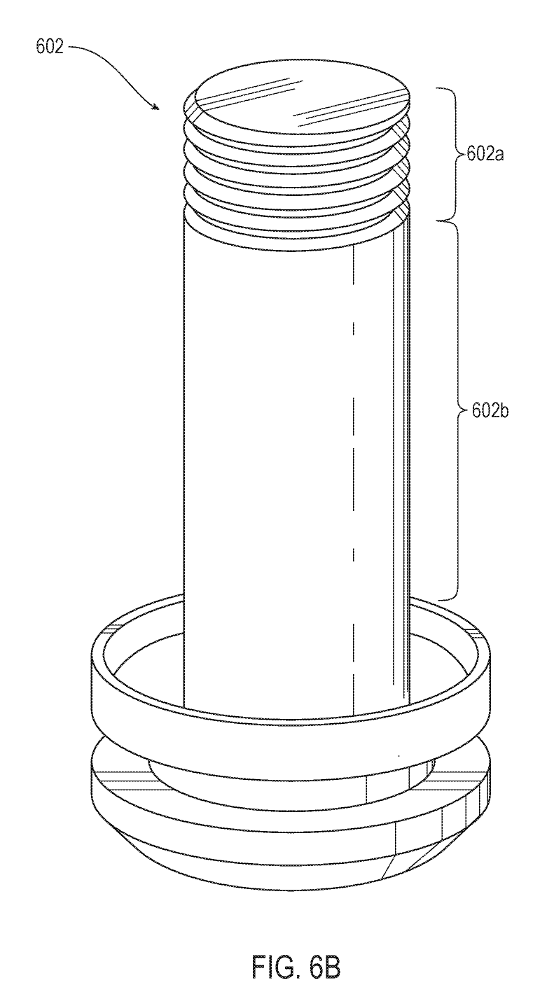

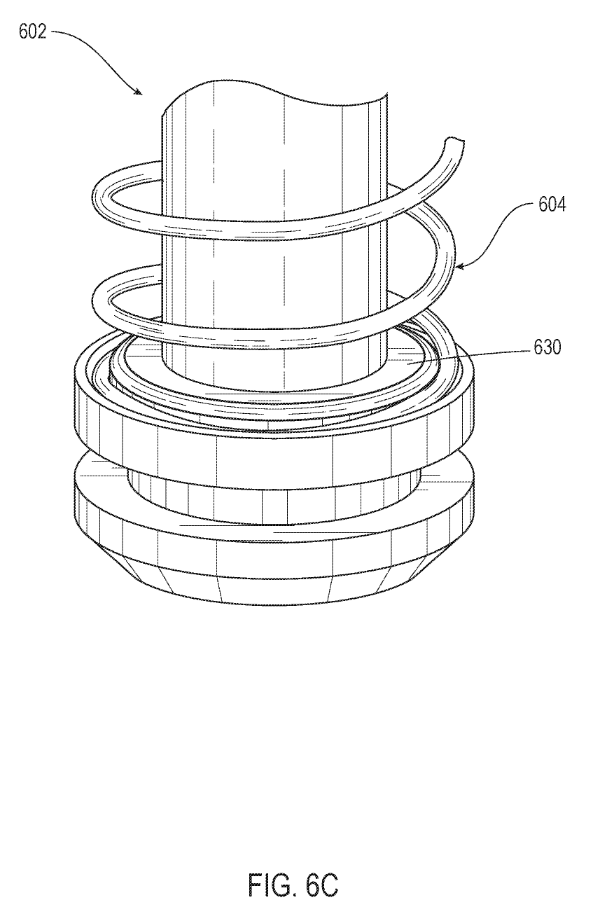

FIG. 6A illustrates a perspective view of a probe structure 600 according to various embodiments. Referring to FIG. 6A, in some embodiments, the probe structure 600 has a first end 600a and a second end 600b. In some embodiments, the first end 600a interfaces with a controller, such as, but not limited to, a motor assembly and the like for controlling the probe structure 100 (e.g., control z-axis pressure, normal alignment, or the like of the probe structure 100). In some embodiments the second end 600b contacts a surface on which the probe structure 600 operates. For example, in some embodiments the second end 600b is configured to contact human skin for operation of the probe structure 600.

In some embodiments, the probe structure is part of a Transcranial Doppler (TCD) apparatus such that the second end 600b of the probe structure 600 is configured to contact and align along a human head, and the first end 600a of the probe structure 600 is connected to the TCD apparatus to provide ultrasound wave emission out of the second end 600b. In other embodiments, the probe structure 600 is configured to emit other types of waves during operation, such as, but not limited to, infrared waves, acoustic, x-rays, and so on.

In some embodiments, the probe structure 600 includes a probe body 602, and a spring 604. In some embodiments the spring 604 wraps around or encircle the probe body 602. In some embodiments the spring 604 provides increased control of and stability to the probe structure 600 during operation. In some embodiments, the probe body 602 may include a TCD probe, ultrasound probe, or a Phased Array probe.

FIG. 6B illustrates a perspective view of the probe body 602 according to various embodiments. Referring to FIG. 6A and 6B, in some embodiments, the probe body 602 includes a threaded section 602a and a shaft 602b. In some embodiments, the threaded section 602a includes a plurality of threads along a portion of the length of the probe body 602. In some embodiments, the threaded section 602a is located at an end of the probe body 602 (e.g., at a portion of the probe body 602 corresponding to the first end 600a of the probe structure 600). In some embodiments, the plurality of threads extends circumferentially around the probe body 602. In some embodiments, the threaded section 602a is configured to interface and connect with other components of a device (e.g., a TCD device). For example, in some embodiments, the threaded section 602a interfaces with a gimbal component.

In some embodiments, the threaded section 602a includes any suitable number of threads for interfacing and securely connecting the probe structure 600 to a separate device. For example, in some embodiments the probe body 602 includes five or six revolutions of threads. In other embodiments, the probe body 602 includes more than six threads or fewer than five threads. In addition, in some embodiments, adjacent threads of the threaded section 602a are offset from each other at a constant distance, such as, but not limited to, 1/16th inch.

In some embodiments, the probe body 602, the threaded section 602a, and the shaft 602b are made from any suitable rigid material for allowing the transmission of waves, electromagnetic energy or acoustic waves (e.g., ultrasound waves), such as, but not limited to, plastics including acrylonitrile butadiene styrene (ABS), polyoxymethylene (POM), acetal, polyacetal, polyformaldehyde, combinations thereof, or the like. In some embodiments, the probe body 602, the threaded section 602a, and the shaft 602b are made from a material capable of withstanding water-based liquids (e.g., ultrasound gel). In some embodiments, the threaded section 602a, the shaft 602b, and the plurality of fingers 606 are made from the same material. In other embodiments, the threaded section 602a, and the shaft 602b are made from different materials, or two of the elements are made from the same materials different from that which the third element is made from (e.g., the threaded section 602a and the shaft 602b are made from the same material, and the fingers are made from a different material than that of the threaded section 602a and the shaft 602b).

In some embodiments, the probe body 602 can be made by any suitable method of manufacturing, such as, but not limited to, overmolding or the like. In particular embodiments, the probe body 602, the threaded section 602a, and the shaft 102b are machined. In other embodiments, the probe body 602, the threaded section 602a, and the shaft 602b are injection molded. In some embodiments, the probe body 102, the threaded section 602a and the shaft 602b are designed with uniform thickness to prevent sink marks, short shots, and flow marks.

FIG. 6C illustrates a perspective view of a portion of a probe body 602 according to various embodiments. FIG. 6C shows a spring securing element, which may be a ring 630 around probe body 602 which keeps spring 604 secured from moving around probe body 602. When spring 604 wraps around ring 630, the movement of spring 604 will be limited from moving around the probe body 602.

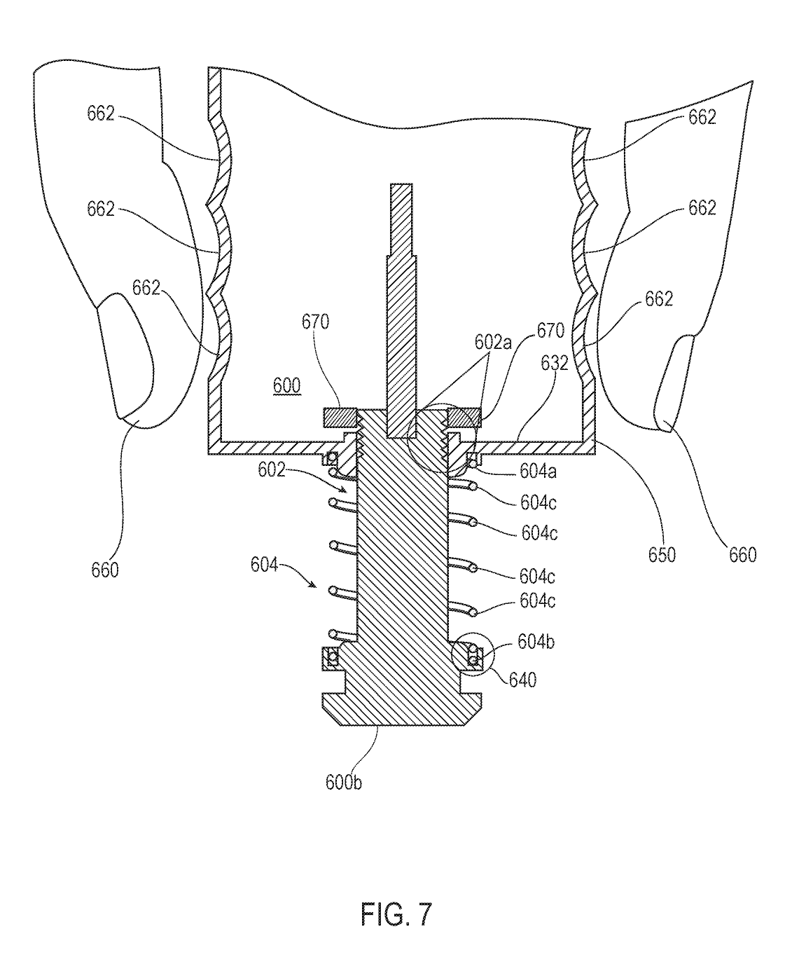

FIG. 7 illustrates a side cross-sectional view of the probe structure 600 according to various embodiments. Referring to FIG. 6A, FIG. 6B, and FIG. 7, in some embodiments, the probe structure 600 includes a spring receptacle 640. In some embodiments, the inner surface of a second end coil 604b wraps around and contacts the spring receptacle 640. In some embodiments, the second end coil 604b includes a plurality of end coils that wrap around the spring receptacle 640. In some embodiments, the plurality of end coils are substantially similar to each other, for example, in shape, diameter, angle of tilt (e.g., pitch), or the like.

In addition, FIG. 7 illustrates a compression plane 632. In some embodiments, the compression plane 632 is located near and contacts the first end coil 604a. In some embodiments, the compression plane 632 represents a structure that attaches to the probe structure 600 that compresses the spring 604. For example, in some embodiments, the compression plane 632 compresses or decompresses the spring 604 during placement and force control of the probe structure 600. In some embodiments, the compression plane 632 represents pressure applied to the spring 604 during operation of a TCD device. In some embodiments, the first end coil 604a corresponds to the second end coil 604b described above, and the disclosure related to the first end coil 604a is applicable to the second end coil 604b. In addition, in some embodiments, the compression plane 632 attaches to or may be part of a grip 650. In some embodiments, the grip 650 is designed to be ergonomically compatible with fingers 660 of a user, and contains indentations 662. In some embodiments, a stopper 670 such as a nut is attached to the threaded section 602a to keep the probe body 602 within compression plane 632. Of course, the stopper 670 may a bolt, pin, flange, or other component known to those of skill in the art that would prevent the stopper 670 from falling out of the compression plane 632. The threaded section 602a is connected to the stopper 670, allowing the probe body 602 to travel and compress the spring 604 against the compression plane 632. The stopper 670 is located on the opposite side of the compression plane 632 as spring 604. This configuration enables an operator to move grip 650 and the probe body 602 to compress and decompress the spring 604 while it is moved along a surface such that the second end 600b stays in contact with the surface.

The above used terms, including “attached,” “connected,” “secured,” and the like are used interchangeably. In addition, while certain embodiments have been described to include a first element as being “coupled” (or “attached,” “connected,” “fastened,” etc.) to a second element, the first element may be directly coupled to the second element or may be indirectly coupled to the second element via a third element.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

What is claimed is:

1. An apparatus comprising:
a probe body;
a spring securing element coupled to probe body;
and a spring comprising a plurality of coils coupled to the probe body.

2. The apparatus of claim 1 wherein an end coil of the plurality of coils is configured to encircle the spring securing element.

3. The apparatus of claim 1 wherein the spring securing element is adapted to extend from the probe body.

4. The apparatus of claim 1 wherein the probe body emits acoustic energy from a first end.

5. The apparatus of claim 1 wherein the probe body is an ultrasound probe.

6. The apparatus of claim 1 wherein the probe body is a transcranial Doppler (TCD) probe.

7. The apparatus of claim 1 wherein the probe body is comprised of an array of transducers.

8. The apparatus of claim 1 wherein the probe body is a near infrared spectroscopy probe.

9. The apparatus of claim 1 wherein the probe body includes a threaded section.

10. The apparatus of claim 9 wherein the threaded section is configured to connect to a position control device.

11. The apparatus of claim 9 wherein the threaded section is connected to a stopper allowing the probe body to travel and compress the spring against a compression plane.

12. The apparatus of claim 11 wherein the compression plane attaches to a grip.

13. The apparatus of claim 9 wherein the spring securing element is at a first end of a shaft, which first end is opposite a second end of the shaft adjacent to the threaded section.

14. The apparatus of claim 13 wherein the spring securing element is adapted to receive or hold one or more of the plurality of coils.

15. The apparatus of claim 14 wherein the spring securing element comprises a plurality of fingers.

16. The apparatus of claim 14 wherein the spring securing element comprises a ring.

17. An apparatus comprising: a probe structure, including a spring comprising a plurality of coils coupled to a probe body; and a compression plane that attaches to the probe structure and compresses the spring.

18. The apparatus of claim 17 wherein the compression plane attaches to a grip.

19. The apparatus of claim 17 wherein a stopper is located on the opposite side of the compression plane from the spring.

20. The apparatus of claim 17 wherein the compression plane provides pressure to the spring during operation of a probe.

21. A probe structure comprising:
a probe body;
a plurality of fingers adapted to extend outwards from the probe body; and
a spring comprising a plurality of coils adapted to wrap around the probe body, and an end coil of the plurality of coils configured to encircle the plurality of fingers.
